(19) United States
(12) Patent Application Publication
(10) Pub. No.: US 2004/0161035 A1
(43) Pub. Date: Aug. 19, 2004

(54) Device for interpolating of scanning values and image encoder and decoder

(76) Inventor: Thomas Wedi, Hannover (DE)

Correspondence Address: KENYON & KENYON, ONE BROADWAY, NEW YORK, NY, 10004, US

(21) Appl. No.: 10/476,100

(22) PCT Filed: Feb. 9, 2002
(86) PCT No.: PCT/DE02/00476

(30) Foreign Application Priority Data
Apr. 25, 2001 (DE) 101 20 395.0

(51) Int. Cl. H04N 7/12

(52) U.S. Cl. 375/240.12; 375/240.01

(57) ABSTRACT

For the interpolation of sampling values for a motion compensated prediction of images of a moving image sequence an interpolation filter device (IF) is used whose filter function is designed to be variably adjustable in a spatially and/or temporally adaptive manner for a range of sampling values of an image associated with a displacement vector.

The present invention is based on a device for interpolating sampling values for the motion compensated prediction of images of a moving image sequence.

### BACKGROUND INFORMATION

The methods for encoding digital video signals use motion compensated prediction to reduce redundancy in the temporal direction, and transform encoding to reduce redundancy in the spatial direction. In order to describe motions that have an amplitude of less than one picture element, the picture signal must be interpolated at positions between the sampling lattice. Current standardized methods for encoding moving image sequences are based on the principle of hybrid encoding. In the first step they use motion compensated prediction (MCP: motion compensated prediction). In this context, the correlation of sequentially occurring images is utilized and the instantaneous picture signal to be encoded is predicted from the preceding, already transmitted picture signal. The remaining prediction error signal is transmitted in a second step with the aid of transform encoding, the redundancy in the spatial being reduced.

For the motion compensated prediction, the picture to be predicted is divided into blocks for which a corresponding block is then searched for in the preceding image. Its position is described with the aid of a two-dimensional so-called displacement vector. The displacement vectors have an amplitude resolution of less than one picture element and thus allow a correspondence with a position in the preceding picture lying between the sampling lattice. Interpolation filters are used to reconstitute the picture signal at positions between the sampling lattice.

### SUMMARY OF THE INVENTION

The method according to the main claims makes it possible to take into account the changes in the picture signal characteristics, in particular the aliasing, as well as changes in the accuracy of the motion estimate, which is not possible with current devices having temporally and spatially invariant interpolation filtering.

The additional claims indicate advantageous developments.

Because of less than ideal low passes in the recording process, aliasing results in the digital image to be encoded. Since aliasing depends on the low passes in the recording system, it differs according to the recording system used. The aliasing-reducing Wiener filters used heretofore are temporally and spatially invariable, however. For this reason, the variable aliasing interferences are not optimally compensated. With the aid of adaptive interpolation filtering whose filter function is designed to be adjustable in a spatially and/or temporally adaptive manner for a range of sampling values of an image assigned to a displacement vector, it is possible to take these variations into account, so that the picture signal may thus be predicted in a more precise manner.

An additional advantage of adaptive interpolation filtering is that variable displacement-estimate errors may be considered. Due to a restricted image model, which, among others, includes the transformation, the resolution of the vectors and the block size, and due to the employed estimation method for the vectors, e.g., RD-based, 3-step search, and due to the respective image content, the displacement vectors are not precise. The resultant displacement-estimate error depends on the respective characteristics of the image model, the estimation method and the picture content and thus varies as to space and time. If these vectors point to a subpel position whose associated signal value is calculated with the aid of an interpolation filter from spatially adjacent signal values, an adaptive filter is able to consider these inaccuracies in the vectors. This results in a further improvement in the prediction and increases the encoding efficiency.

The present invention improves the motion compensated prediction and consequently the encoding efficiency of a hybrid video-encoding method. This is achieved by using an, in particular, adaptive FIR filter in the motion compensated prediction. With the aid of this adaptive filter, it is possible to take variable aliasing interferences and variable displacement-estimate errors into account in the prediction.

### BRIEF DESCRIPTION OF THE DRAWING

Exemplary embodiments of the present invention are explained in greater detail on the basis of the drawings.

The figures show:

FIG. 1 a block diagram for the principle of hybrid encoding;

FIG. 2 a block diagram of a hybrid video encoder/decoder with transmission of the selected filter coefficients;

FIG. 3 a block diagram of a hybrid video encoder/decoder without transmission of the selected filter coefficients.

### DESCRIPTION OF THE EXEMPLARY EMBODIMENTS

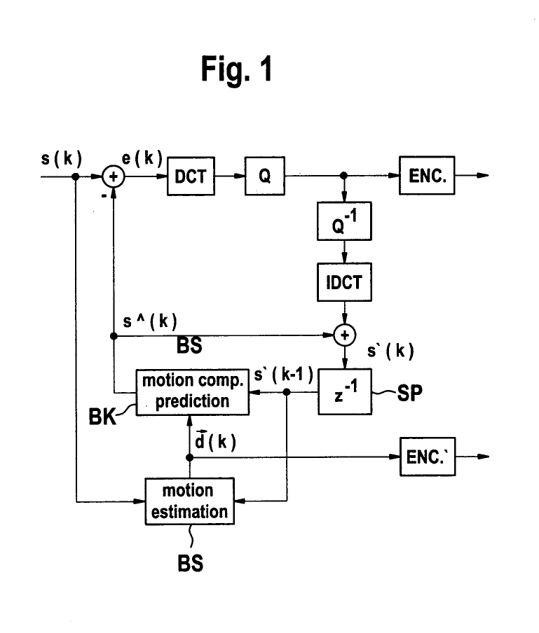

The block diagram for the hybrid encoding shown in FIG. 1 includes the following components: From the input signal s(k) to be encoded and an estimated value s\hat{ }(k) the prediction residual error e(k) is determined using subtraction. The latter is transform-encoded (block DCT), quantized (Q) and channel-encoded (ENC) for the subsequent transmission. The estimation signal s\hat{ }(k) is obtained by a picture signal s′(k−1) that precedes it in time, using a motion estimator BS and motion compensated prediction (step BK). For this purpose, the transform-encoded and quantized prediction residual error e(k) is transduced by means of inverse quantization Q−¹ and inverse transform IDCT and forwarded to picture storage SP, which always stores the temporally preceding picture signal s′(k−1). The instantaneous picture signal s(k) is compared to the picture signal s′(k−1) in stage BS, and a displacement vector d(k) is generated on the basis of the comparison, which is channel-encoded as well (ENC′). Based on the determined displacement vector d(k), estimation signal s\hat{ }(k) is generated in stage BK using signal s′(k−1). The processing of the picture data is implemented, in particular, block by block, i.e., for each region (block) of sampling values of the image assigned to a displacement vector d(k), a particular filter function, or one of a plurality of different interpolation filters, is selected. In place of blocks, it is also possible to generate displacement vectors for other groups of sampling values, such as for certain contours in the case of contour encoding.

In contrast to motion compensated prediction using a non-adaptive filter, the filter function of the filtering device of the present invention is a function of time and/or location. The filter coefficients of an adaptive filter change with time and/or location, the validity of the filter coefficient being variable in this context. They may be valid, for example, for a plurality of pictures, for one image in each case or only for certain picture regions within a picture.

There are different possibilities for determining the filter coefficients, these being described in more detail in the following. There are likewise various possibilities for making the coefficients accessible to the decoder and these will be introduced as well.

In order to find the optimal filter coefficients for the interpolation filtering device in the encoder, the following measures are taken according to the present invention:

a) Estimation of the Coefficients by Minimizing the Prediction Error Output.

In this measure for estimation, the coefficients are estimated such that the prediction error of the entire motion compensated prediction e(k) (compare FIG. 1) is minimized. This may be achieved by the following steps:

1. Estimating the displacement vectors d(k) with the aid of a Wiener filter;

2. Estimating the filter coefficients, which minimize the output of prediction error e(k) when applying the displacement vectors d(k) from step 1.

In this context, it is possible to employ the measures iteratively, i.e., on the basis of the filter estimated in step 2, the displacement vectors are estimated again and the filter improved with the aid of the new vectors, etc.

b) Selection of the Filters from a Limited Number of Predefined Filters

In this measure, a particular set of filters is provided and the optimal one selected from only this limited number of filters. If only data that have already been transmitted are used in the selection of the filters, no additional page frame data must be transmitted since the decoder has the same data available. Possible selection criteria are, for instance: Evaluation of already transmitted prediction error signals:

by analyzing the variance;

by frequency analysis, of the transform coefficients, for example.

Evaluation of the already transmitted displacement vectors d(k):

length;

adjacent displacement vectors

Another possibility for selecting a filter from a set of predefined filter devices is the transmission of an index. In the process, each filter is assigned its own index by which it may be identified. This is useful when, for instance, the filter coefficient is selected on the basis of data that are not accessible to the decoder.

If the motion compensated prediction (MCP) with adaptive filters is used in the framework of a hybrid video encoding method, it is necessary to make the filter coefficients used in the MCP of the encoder accessible to the MCP of the decoder. The following possibilities exist to determine the filter coefficients in the decoder:

A) Determining the Filter Coefficients by Transmitting Additional Page Frame Data

With this method, there are basically two possibilities:

1. The coefficients are encoded and transmitted with the aid of, for instance,

a) PCM encoding;

b) DPCM encoding, the preceding, already transmitted coefficients being used for predicting the coefficients to be encoded.

2. The coefficients are not transmitted directly, but an index is transmitted instead, which selects the coefficients from a table with different filters. The possible number of different filters is restricted to the number of filters in the table.

B) Determination of the Coefficients from the Already Transmitted Data, i.e., Without Transmitting Additional Page Frame Data

If only data that was already transmitted is used for selecting the filter, no additional page frame data has to be transmitted. The decoder is then able to select the filter using the same method as the encoder. Possible selection criteria have already been described in connection with the encoder.

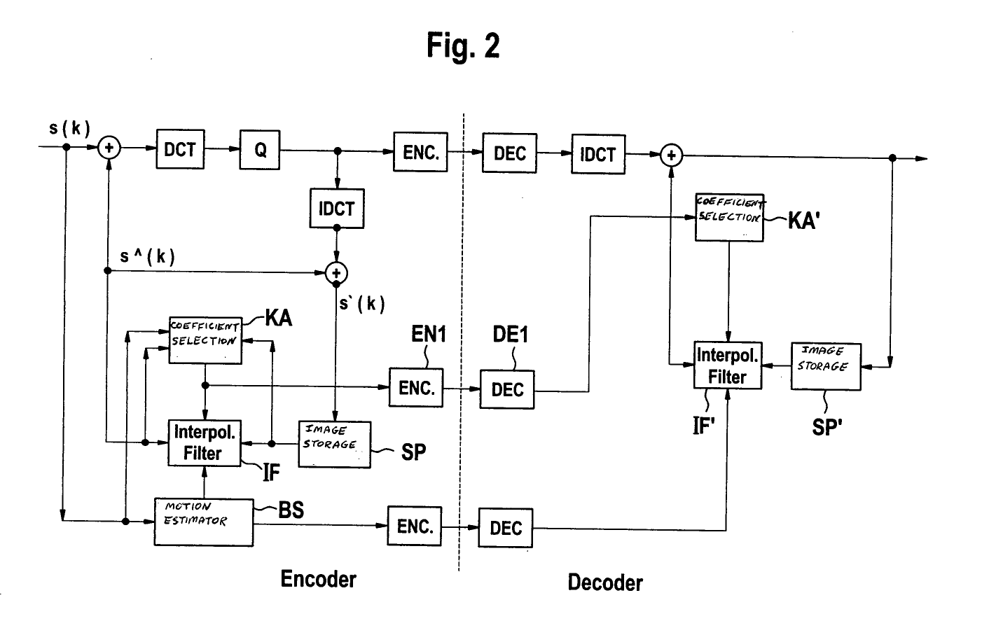

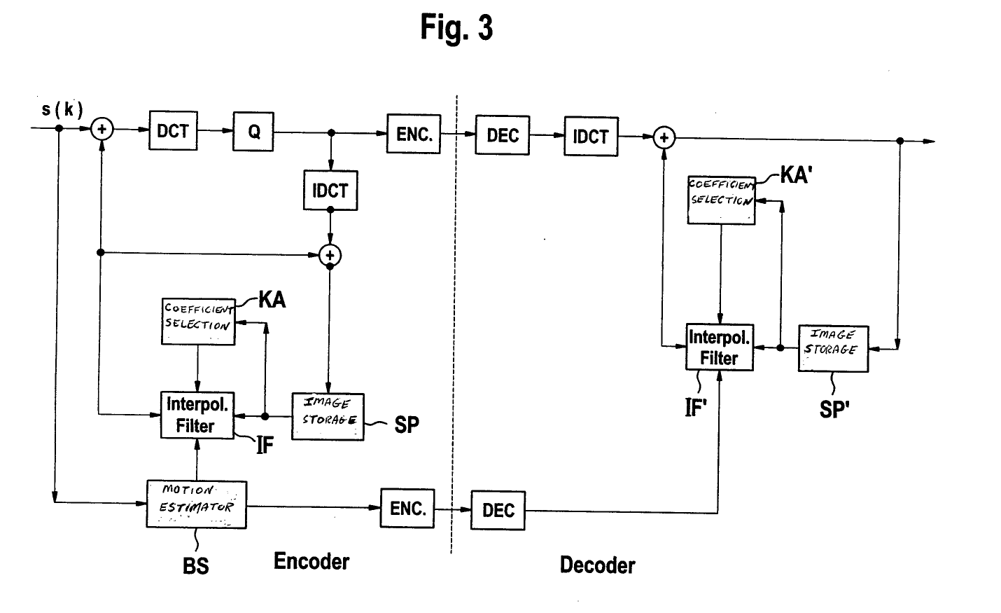

On the basis of the block diagram according to FIG. 1, the components provided for implementing the present invention are described in greater detail in FIGS. 2 and 3. FIGS. 2 and 3 each show a video encoder and an associated video decoder having adaptive motion compensation according to the present invention. Motion-compensation step BK according to FIG. 1 includes as most essential unit the interpolation filter device designated IF in FIGS. 2 and 3. The filter coefficients for this interpolation filter device IF are set via coefficient selection step KA. This obtains its necessary data, that is, the respective position between the sampling lattice (subpel data) of the picture data to be interpolated, by comparing instantaneous picture data s(k) with corresponding picture data of the image s(k−1) that preceded it in time. In the design according to FIG. 2, this coefficient selection is carried out on the encoder side and is separately transmitted to the decoder together with the remaining picture data (via channel encoding step EN1 and channel-decoding step DE1). There, the transmitted coefficient-selection data (page frame data or index for filter selection) is used to control the receiver-side, i.e., decoder-side, coefficient-selection step KA′. In the development according to FIG. 3, no filter coefficients/indexes are transmitted. They are determined from already transmitted data in the manner described earlier.

What is claimed is:

1. A device for interpolating sampling values for the motion compensated prediction of images of a moving image sequence, wherein interpolation filtering (IF) is provided whose filter function is designed to be variably adjustable in a spatially and/or temporally adaptive manner for a range of sampling values of an image associated with a displacement vector.

2. The device as recited in claim 1, wherein the filter device includes a set of a plurality of individual filters and one of the plurality of individual filters is selectable for interpolation filtering (IF) for each range of sampling values of an image associated with a displacement vector.

3. An image encoder for the transmitter-side conditioning of transmission signals for a motion compensated prediction of images of a moving image sequence, wherein an interpolation filtering device (IF) is provided for interpolation of sampling values for the motion compensated prediction whose filter function is designed to be variably adjustable in a spatially and/or temporally adaptive manner for a range of sampling values of an image associated with a displacement vector, and the filter coefficients for adjusting the interpolation filtering device are selected such that the output of the prediction error for an estimated displacement vector is minimal.

4. The image encoder as recited in claim 3, wherein the filter coefficients for adjusting the interpolation filtering device (IF) are available at an output (EN1) of the image encoder so as to transmit them to an image decoder, in particular.

5. An image encoder for the receiver-side conditioning of transmission signals for a motion compensated prediction of images of a moving image sequence, wherein an interpolation filtering device (IF) is provided for interpolation of sampling values for the motion compensated prediction whose filter function is designed to be variably adjustable in a spatially and/or temporally adaptive manner for a range of sampling values of an image associated with a displacement vector and the filter coefficients for adjusting the interpolation filtering device (IF) are selected such that the output of the prediction error for an estimated displacement vector is minimal.

6. The image encoder as recited in one of claims 3 or 4 and the image decoder as recited in claim 5, wherein the filter coefficients for improving the motion compensated prediction are determined iteratively.

7. The image decoder as recited in claim 5, wherein the interpolation filtering device (IF) includes a set of a plurality of individual filters, one of the plurality of individual filters being selectable for interpolation filtering (IF) for each range of sampling values of the image associated with a displacement vector.

8. The image decoder as recited in claim 7, wherein an index is provided for selecting a respective individual filter, the index being conditionable, in particular by the encoder, and transmittable together with the image data.

9. The device as recited in claim 1 or 2, the image encoder as recited in one of the claims 3 through 5, or the image decoder as recited in claim 7 or 8, wherein the interpolation filtering device (IF) is made up of an adaptive FIR filter.
